(19) United States
(12) Patent Application Publication
(10) Pub. No.: US 2009/0220827 A1
(43) Pub. Date: Sep. 3, 2009

(54) Monitoring fuel cells using rfid devices

(76) Inventors: Leslie Brenon Knaggs, Coquitlam (CA); Fariborz T. Ordubadi, North Vancouver (CA); Edwin J. Vink, Langley (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 10/583,122

(22) PCT Filed: Dec. 16, 2004
(86) PCT No.: PCT/US04/42854

§ 371 Date: Apr. 21, 2009

Related U.S. Application Data
(60) Provisional application No. 60/714,532, filed on Dec. 19, 2003.

(30) Foreign Application Priority Data
Dec. 21, 2005 (US) 10/740693

(51) Int. Cl. H01M 8/04

(52) U.S. Cl. 429/13; 429/22; 429/23; 429/25

(57) ABSTRACT

Radio frequency identification (RFID) devices may be used to monitor various operating parameters in fuel cells. For example, RFID devices may be used to monitor the voltage of individual cells in a fuel cell stack and thus to check for voltage reversal conditions during stack operation.

### BACKGROUND OF THE INVENTION

1. Field of the Invention

The present invention relates generally to uses of radio frequency identification (RFID) devices in fuel cells, and, more particularly, to monitoring cell voltages and other operating parameters in solid polymer electrolyte fuel cell stacks.

2. Description of the Related Art

Electrochemical fuel cells convert fuel and oxidant to generate electrical power and reaction products. A representative type of fuel cell is the solid polymer electrolyte fuel cell which employs a solid polymer, ion exchange membrane electrolyte. The membrane electrolyte is generally disposed between two electrode layers (a cathode and an anode layer) to form a membrane electrode assembly (MEA). In a typical solid polymer electrolyte fuel cell, the MEA is disposed between two electrically conductive separator or fluid flow field plates. Fluid flow field plates have at least one flow passage formed therein to direct a fluid reactant (either fuel or oxidant) to the appropriate electrode layer, namely, the anode on the fuel side and the cathode on the oxidant side. The flow field or separator plates also act as current collectors and provide mechanical support for the MEAs.

Since the output voltage of a single fuel cell is relatively low (e.g., less than one volt under load), fuel cell power supplies typically contain many cells that are connected together, in series or in parallel, in order to increase the overall output voltage and power of the supply. In a series configuration, the fuel cells are typically arranged in a stack such that one side of a given flow field plate serves as an anode side plate for one cell while the other side of the plate serves as the cathode side plate for the adjacent cell. Such a flow field plate is referred to as a bipolar plate. A stack of multiple fuel cells is referred to as a fuel cell stack. The fuel cell stack is typically held together in its assembled state by tie rods and end plates. A compression mechanism is generally required to ensure sealing around internal stack manifolds and flow fields, and also to ensure adequate electrical contact between the surfaces of the plates and MEAs.

Depending on the application, significant subsystems and controls may be required to turn a fuel cell stack into a practical power supply. For instance, subsystems generally must provide reactants to the stack at proper pressures and rates in accordance with the applied electrical load. The practical operation of a complete fuel cell system can thus be quite complex and various process or operating parameters may need to be monitored to provide feedback for satisfactory control and/or to provide a warning in the event of an impending problem condition.

An example of an important potential problem condition in series stacks is voltage reversal in a cell (or cells). (Voltage reversal can occur in a weaker cell in a series stack when that cell is incapable of providing current at the same level as other cells in the stack. In such a situation, a sufficiently high current generated by the other cells in the stack is forced through the weaker cell and drives it into voltage reversal.) Aside from being associated with a reduction in output power, voltage reversal also can result in internal damage to the reversed cells and the stack. It can therefore be useful to monitor individual cell voltages and to detect for any abnormally low voltage during operation in order to provide advance warning of a voltage reversal condition. In turn, corrective action can then be taken to prevent cells from undergoing voltage reversal, and thus prevent any reversal-related damage from occurring.

However, it has proven difficult to develop a suitable cell voltage monitor (CVM) for this purpose. A typical CVM collects voltage data via suitable electrical connections to the individual cells. Signals representative of the cell voltages are then generated and supplied to a processor which then determines whether a problem condition exists and initiates appropriate action. Since the typical processor cannot handle high common mode voltages (i.e., voltages with respect to a common voltage or common ground) and since the voltages encountered in the typical series stack can be quite high (e.g., up to hundreds of volts between cells), the generated signals are usually electrically isolated from the cells themselves via appropriate isolation circuitry. Problems have been encountered though with the electrical connections made to the cells and with the circuitry that generates the electrically isolated signals representative of the cell voltages.

With regards to making electrical connections to the cells, the assembly required is very labour intensive and it is becoming more difficult to align and install contacts as the designs of fuel cells advance and as the separator plates become progressively thinner and more closely spaced. Further, variations in the cell-to-cell spacing (due to manufacturing tolerances and to expansion and contraction during operation of the stack) must be accommodated. Further still, the fuel cell stack may be subject to vibration and thus reliable connections must be able to maintain contact even when subjected to vibration.

The signal generation/electrical isolation circuitry in a CVM is desirably located close to the electrical connections to the cells and hence close to the stack. (This minimizes the high voltage hardware required and the size of the hazardous voltage region in the system. Also the possibility of inadvertently shorting out cells in the stack through the CVM may be reduced.) However, in the immediate vicinity of the stack, the environment may be humid, hot, and either acidic or alkaline. For instance, in solid polymer electrolyte fuel cells, carbon separator plates may be somewhat porous and thus the environment in the immediate vicinity of the plates can be somewhat similar to that inside the cells. Consequently, any metallic hardware in the immediate vicinity of the stack may be subject to corrosion and failure. In particular, conductive traces that separate large voltages (e.g., in printed circuit board based isolation circuitry) are subject to corrosion and bridging via dendrite formation. To prevent this type of failure, such hardware can be appropriately encapsulated or potted to isolate it from the corrosive environment. Still, it is not trivial to provide a satisfactory comprehensive, durable protective coating in this way.

Accordingly, although there have been advances in the field, there remains a need for simple, reliable cell voltage monitors for fuel cell stacks. The present invention addresses these needs and provides further related advantages.

### BRIEF SUMMARY OF THE INVENTION

Radio frequency identification (RFID) devices may be used to monitor various operating parameters in fuel cells, including, for instance, the voltage of individual cells in a fuel cell stack. Thus, an RFID system may serve as an improved cell voltage monitor to check for voltage reversal conditions in individual cells during stack operation.

In order to monitor an operating parameter, an RFID transponder is provided in the fuel cell and the transponder is configured to sense and transmit information about that operating parameter.

In one embodiment, the transponder may be configured to transmit its identification only when the operating parameter reaches a certain threshold value (e.g., when the parameter falls below or alternatively when it exceeds the threshold value). In a different embodiment, the transponder may instead be configured to transmit the actual value of the operating parameter.

As mentioned above, the monitored operating parameter can be the cell voltage. However, it is also possible to monitor other operating parameters such as cell impedance. Both cell voltage and impedance may be sensed by incorporating a sensor in the transponder which has a cathode contact and an anode contact electrically connected to the cathode and the anode in the fuel cell, respectively.

Half cell voltages (i.e., the voltage between a suitable reference electrode and one of the cathode or anode voltages) may be monitored if a suitable reference electrode is employed in the fuel cell. The transponder would then comprise a voltage sensor that includes the reference electrode.

Other parameters that may also be monitored include the cell temperature, a reactant pressure and/or flow rate, stack compression, and an impurity concentration. With appropriate sensors incorporated in the transponders, more than one parameter can be sensed and hence monitored at the same time using the inventive apparatus.

Along with appropriate sensors to sense the desired operating parameters, the transponder may comprise an A/D converter to convert the sensed parameters into digital form for transmission. The transponder may be active (internally powered) or passive (externally powered, typically via interaction with an RFID reader).

An RFID monitored fuel cell system would typically comprise a series stack of a plurality of the above transponder equipped fuel cells along with a reader for reading information transmitted from the transponders.

In an exemplary embodiment, the system is a solid polymer electrolyte fuel cell system in which the invention serves as a cell voltage monitor to protect against voltage reversal. In the fuel cell stack, each cell comprises a membrane electrode assembly and each membrane electrode assembly comprises a cathode, an anode, an electrolyte and an electrochemically inactive manifold section. The stack further comprises flow field plates adjacent the anode and cathode of each fuel cell. Each cell is equipped with a transponder located in the manifold section of the membrane electrode assembly. The transponder comprises a voltage sensor with a cathode pressure contact pad and an anode pressure contact pad mounted on opposing faces of the manifold section such that they electrically contact the flow field plates adjacent the cathode and anode, respectively. The manifold section is a thermoplastic and the transponder may be molded therein at the time of manufacture.

In the foregoing embodiment, the transponders sense and transmit information regarding the cell voltage to the reader. However, to avoid any “collision” issues in this application (where signals from many transponders may interfere with each other), it is possible to have the transponders in each fuel cell remain dormant (silent) unless the cell voltage falls below some threshold value indicative of an impending voltage reversal. Thus, the transponders are configured to transmit their identification to the reader only when the cell voltage falls below this threshold value.

### BRIEF DESCRIPTION OF THE SEVERAL VIEWS OF THE DRAWING(S)

FIG. 1 shows a schematic diagram of a solid polymer electrolyte fuel cell system that includes a cell voltage monitor based on RFID devices.

FIG. 2a shows a schematic diagram of a transponder configured to transmit its identification in response to a sensed operating parameter.

FIG. 2b shows a schematic diagram of a transponder configured to transmit data representative of a sensed operating parameter.

FIGS. 3a and 3b show an assembled view and an exploded view, respectively, of a possible mounting arrangement for a voltage monitoring transponder in a fuel cell unit of a solid polymer electrolyte fuel cell stack.

FIG. 4 shows the model described in Example 1 of a cell voltage monitoring transponder.

FIG. 5 shows the model described in Example 2 of a cell voltage monitoring transponder.

### DETAILED DESCRIPTION OF THE INVENTION

Radio frequency identification (RFID) devices are used in various industries to identify and track goods. In a typical tracking application, each item to be tracked contains an RFID transponder and an item is identified using an RFID reader which communicates with the transponder at radio frequencies and determines its identification. RFID devices are slowly replacing barcodes as the technology continues to advance and the size and price of the devices drop. RFID devices offer several advantages over barcodes in that they do not need to be visible (i.e., can be embedded in an object) and they can provide a memory function.

An RFID system has at least one RFID transponder (which is often called a tag and typically comprises an integrated circuit and an appropriate coil/antenna), and at least one reader (which comprises a transceiver and an appropriate coil/antenna). Communication takes place between transponder(s) and reader(s) via magnetic coupling between their coils (that is, together the coils act like an air core transformer). The typical frequency band for operation is in the range of about 30 KHz to 2.5 GHz.

In the fuel cell industry, RFID technology can be valuable not only for identifying and tracking components and/or products but also for monitoring various parameters in the fuel cell stack itself while it is operating. Although there can be significant electromagnetic noise in the vicinity of powerful fuel cell stacks when in use, it is possible in general for RFID devices to communicate successfully in this environment. (Although, the noise level in certain locations may be unacceptable, as noted in the Examples below.)

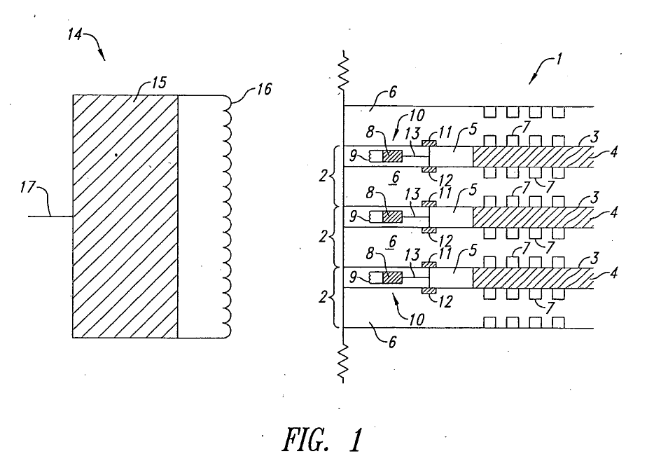

While a number of parameters might desirably be monitored while operating a stack, it is particularly useful to be able to monitor individual cell voltages in order to provide advance warning of an impending voltage reversal condition. FIG. 1 shows a schematic diagram of an exemplary solid polymer electrolyte fuel cell system which includes a cell voltage monitor in which RFID devices are used to monitor each cell in the stack.

In FIG. 1, stack 1 comprises a plurality of fuel cell units 2 in a series stack (for simplicity, only three units are shown in detail in FIG. 1). Each unit 2 in the stack comprises a membrane electrode assembly (MEA) 3. MEA 3 comprises an electrochemically active portion 4 and an inactive portion 5. Active portion 4 comprises a cathode, an anode, and an electrolyte (not specifically shown). In the illustrated embodiment, inactive portion 5 may serve to form internal manifolds for reactants and/or coolant. Each fuel cell unit 2 also comprises bipolar separator plate 6 with cathode and anode flow fields 7 formed therein adjacent the cathode and anode, respectively, of adjacent MEAs 3. In this way, flow fields 7 in bipolar plate 6 serve to distribute oxidant and fuel reactants to the cathode and anode, respectively.

In accordance with the invention, an RFID transponder 10 comprising integrated circuit 8 and coil 9 is incorporated into each fuel cell unit 2. To sense the cell voltage, transponder 10 also includes cathode contact pad 11 and anode contact pad 12 on opposite sides of inactive portion 5 but near active portion 4. Pads 11 and 12 physically contact the cathode and anode sides of adjacent bipolar plates 6, respectively, and are electrically connected to voltage inputs on integrated circuit 8 via sense lines 13.

The cell voltage monitor in FIG. 1 comprises transponders 10 and reader 14 which is located within communication range of transponders 10. Reader 14 comprises transceiver 15 and coil 16. Information representative of the individual cell voltages is communicated by transponders 10 to reader 14. In turn, reader 14 forwards cell voltage information via line 17 to a processor (not shown) which analyzes the information, determines if a problem condition exists, and initiates appropriate action.

The system of FIG. 1 provides many advantages over prior cell voltage monitoring systems. Communication between transponders 10 and reader 14 is wireless and no external electrical connections are required, thereby reducing complexity and the possibility of electrical shorting between cells. Transponders 10 are electrically isolated from reader 14 and thus there are no high voltage isolation issues associated with the latter. Further, line of sight is not required between reader 14 and the fuel cell stack, so reader 14 can be isolated more from the corrosive environment around the stack. Another advantage is that the transponders 10 function independently and thus failure of a single transponder need not affect the functioning of the rest of the cell voltage monitor. Yet another advantage is that the components required for the cell voltage monitor shown in FIG. 1 are relatively inexpensive, small, and, to a great extent, generic components that are readily available industrially. Finally, the RFID system may be used to perform additional functions. During manufacture of the depicted stack, the component MEAs can be identified and tracked in a conventional manner using the embedded transponders. In addition, operating parameters other than cell voltage might also be monitored at the same time, simply by incorporating appropriate additional sensors in the transponders and by sharing the other existing hardware (e.g., reader 14).

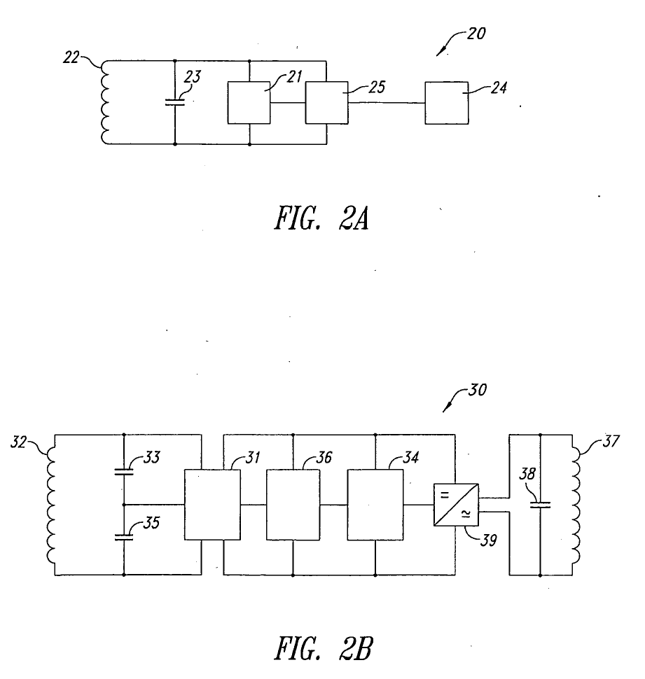

Depending on what information is desired, the transponders can be configured to transmit information only when a problem condition exists or alternatively can be configured to continuously transmit information about the measured parameter. Where the application allows, the former may be preferred since reducing the transmission volume and/or the number of transmitting transponders reduces concerns about “tag collision” (i.e., where transponders sending signals at the same time confuse the reader). However, in the latter case, standard industry practices may be adopted to address any “tag collision” issues (e.g., with anti-collision software). FIGS. 2a and 2b show schematics of general transponder configurations suitable for each case. In FIG. 2a for instance, the transponder is configured to transmit its identification only when the sensed parameter crosses a threshold value. In FIG. 2b, the transponder is configured to transmit data representative of the parameter value itself.

In FIG. 2a, transponder 20 employs a conventional RFID integrated circuit 21 which transmits the transponder identification when queried by the reader. Also shown in the schematic is a conventional transponder coil 22 and tuning capacitor 23. (Tuning capacitor 23 may optionally be included within integrated circuit 21.) To enable transponder 20 to sense and transmit information regarding an operating parameter, transponder 20 also comprises sensor 24 and silencing circuit 25. Sensor 24 senses the parameter to be monitored and supplies a representative signal to silencing circuit 25. When the measured parameter is in a normal range, silencing circuit 25 electrically de-energizes integrated circuit 21 and prevents transponder 20 from transmitting its identification when queried by the reader (thereby silencing transponder 20). However, when the measured parameter crosses a predetermined threshold value, silencing circuit 25 is disabled, thereby allowing transponder 20 to respond when queried. Thus transponder 20 is dormant until a problem condition is sensed, at which point transponder 20 transmits its identification when queried by the reader.

A configuration like that depicted in FIG. 2a is suitable for a cell voltage monitor if all that is needed is a warning of an impending voltage reversal situation. In such a case, silencing circuit 25 may be disabled when the cell voltage drops below a threshold value. Thus, only that cell or cells with voltages below this threshold will respond when queried by the reader, thereby avoiding “tag collision”. In the embodiment of FIG. 1, cathode and anode contact pads 11, 12 serve as sensor 24. Silencing circuit 25 may simply comprise an appropriately configured transistor and capacitor (as illustrated in the Examples below). In a different embodiment, transponder 20 can be configured to transmit at two different thresholds, the first to transmit an advance warning and the second to initiate a shutdown of the fuel cell stack. To do so, two levels of identification are required along with similar silencing circuitry.

In FIG. 2a, conventional RFID integrated circuit 21 is typically passive, i.e., the modest power required to power it and thus to transmit the transponder identification is obtained from interaction with the reader. Sensor 24 and silencing circuit 25 may obtain power from the cell (in the case when cell voltage is monitored) or other target when it is possible to do so. Alternatively, power may be obtained from interaction with the reader (either from the loop comprising coil 22, capacitor 23, and integrated circuit 21 or from a secondary coil circuit, as in FIG. 2b-not shown in FIG. 2a). However, transponder 20 may also incorporate an alternate energy storage, such as a capacitor or battery, and thus be active instead.

FIG. 2b shows an alternate transponder 30 in which the actual value of the monitored operating parameter is provided to a reader. Here, a custom integrated circuit 31 is employed which transmits the cell (i.e., transponder) identification along with encoded information about the value of the operating parameter. Here, sensor 34 senses the operating parameter and supplies a signal to A/D converter 36. A/D converter 36 then converts this analog data into a digital signal which is supplied to custom integrated circuit 31. Finally, integrated circuit 31 encodes the operating parameter data for transmission.

FIG. 2b shows an optional dual capacitor tuned coil arrangement comprising coil 32, first capacitor 33, and second capacitor 35. This arrangement allows for transmissions at two different frequencies. (Alternatively, a single capacitor tuned coil arrangement similar to that shown in FIG. 2a may be used instead.)

As shown in FIG. 2b, power for the various components in the transponder may be obtained via a secondary coil arrangement comprising secondary coil 37, tuning capacitor 38, and full or half-wave rectifier 39. Power can thus be obtained via interaction with the reader at another frequency. Other options for powering the components may be employed however instead of the depicted secondary coil arrangement (e.g., battery).

Whatever transponder configuration is selected, both the transponders and the reader(s) should be located where electromagnetic noise cannot interfere with their operation. As illustrated in the Examples below, RFID systems of the invention are quite robust and can operate properly in all but perhaps the noisiest locations (e.g., adjacent a high power inverter) in a typical high power fuel cell system.

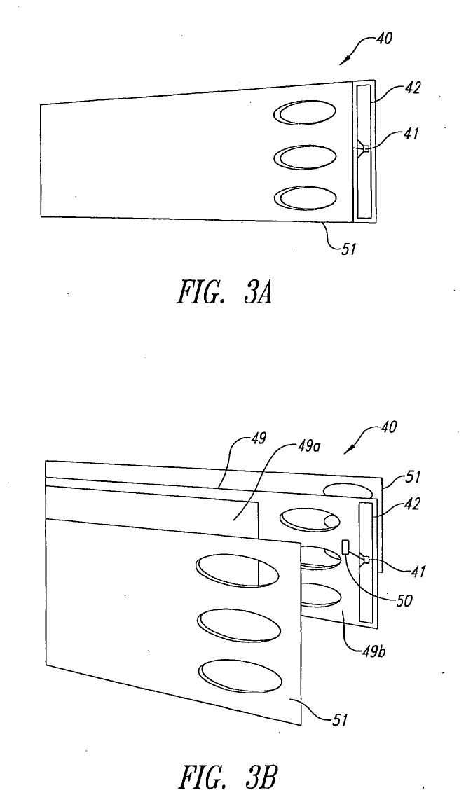

For cell voltage monitoring purposes, a possible mounting arrangement for a transponder in a solid polymer electrolyte fuel cell 40 is shown in FIGS. 3a and 3b. (FIGS. 3a and 3b show an assembled view and an exploded view, respectively.) In these figures, integrated circuit 41 and coil 42 are embedded in a plastic, electrochemically inactive, manifold section 49b at the end of MEA 49. (Internal manifolds for carrying reactants and coolant in the fuel cell stack are created by aligning the manifold openings in MEA 49 along with other components in the cell stack.) Voltage sensing cathode pressure contact pad 50 and anode pressure contact pad (not shown) are mounted on opposite faces of inactive section 49b and press against the cathode flow field side of bipolar plate 51 and the anode flow field side of an adjacent bipolar plate 51 in the assembled cell. The cathode and anode pads are located close to electrochemically active section 49a in an area where the local voltage is sufficiently representative of the cell voltage (under high electrical load, there can be a significant variation in voltage along the active section of the fuel cell). The pads should be made of a material that is suitable for use within the cell environment, such as that used in bipolar plates 51 (e.g., carbon). The conductors connecting cathode and anode pads to integrated circuit 41 may also be embedded in plastic manifold section 49b to protect them from the cell environment. The transponder components depicted here can readily be molded into manifold section 49b during manufacture. The pressure contact pads can be covered during the molding operation such that the contact surfaces remain exposed prior to assembling the fuel cell stack (e.g., with removable tape).

While a suitable application for the invention is for use as a cell voltage monitor, it may be desirable to monitor other operating parameters as well. Typically, the modifications required would be to the sensor type and its mounting arrangement and/or to the internals of the integrated circuit. For instance, to monitor cell impedance (primarily electrolyte impedance) in order to check electrolyte hydration in-situ, similar hardware to that described above might be employed. An appropriate current signal would typically be superimposed across the entire fuel cell stack and cell impedance would be determined from the voltage difference that results in the measured cell. Half cell voltages (i.e., the voltage between a reference electrode and one of the cathode or anode) might be made in a similar manner by incorporating a reference electrode in a suitable location within the cell (e.g., within the membrane electrolyte in a sensitive area, such as in the vicinity of a reactant port).

Cell temperature may be monitored using various temperature measuring devices as a sensor (e.g., thermocouple, thermistor). To monitor reactant pressures (for instance, to detect for blockages or “flooding”) or stack compression (to watch for a sudden loss of stack compression), pressure sensors comprising strain gauge bridges may be used. In the former, a suitable location for the sensor could be in a manifold or flow field passage for that reactant. In the latter, the sensor could act as a load cell and be located in a region under significant compression in one or both end cells in the stack. Other parameters that might be monitored include a reactant flow rate (thus requiring a flow rate sensor) or perhaps the concentration of an impurity in a reactant stream (such as CO in the fuel stream or hydrogen in oxidant stream, and thus requiring a concentration sensor for the impurity species).

If RFID devices are used elsewhere in a fuel cell powered system, the invention offers possible integration advantages. For instance, the same readers might be used to monitor subsystem parameters (e.g., in the oxidant or fuel supply subsystems) as well as to monitor the fuel cell operating parameters. Furthermore, incorporating RFID devices in the fuel cell components allows for conventional inventory and tracking of the components and/or assemblies.

While the preceding discussion has been directed primarily at solid polymer electrolyte fuel cell types, the invention may be used in other suitably low temperature fuel cell types. A limitation of course is the maximum temperature that the transponders can handle (at present, commercially available devices are rated up to about 125° C.).

### Example 1

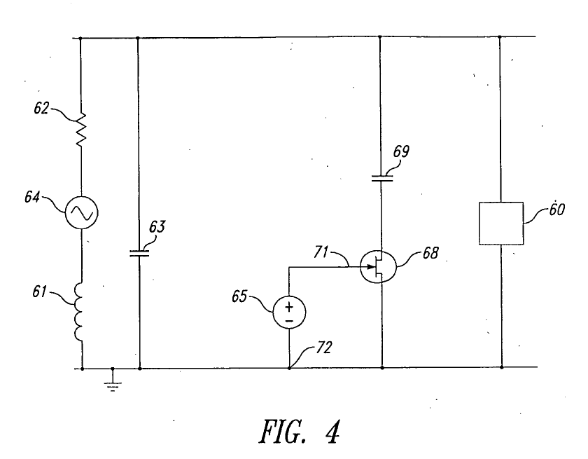

A cell voltage monitoring system was designed for use in a solid polymer electrolyte fuel cell stack. The transponder design was similar to that generally shown in FIG. 2a and used commercially available RFID components, including a microID MCRF200 tag comprising a 125 kHz chip programmed in-house and a microID Reader. (These components are part of a microID Developer's kit that can be obtained from Microchip.) FIG. 4 shows a model of the operating transponder. In the model circuit of FIG. 4, chip 60 represents the aforementioned 125 kHz chip and coil 61 is a conventional coil provided with the kit. Resistor 62 and capacitor 63 represent the resistance and capacitance found in the modeled circuit and signal 64 represents the voltage induced in the circuit via interaction with the reader. The conventional circuit was modified by providing cathode and anode voltage inputs from simulated cell 65 at points 71 and 72, respectively, and transistor 68 and capacitor 69 were added to act as a silencing circuit. When the voltage of cell 65 is greater than −0.3 V, the transistor 68/capacitor 69 silencing circuit should de-tune the circuit, thereby preventing the transponder from transmitting its identification when queried by the reader. However, when the voltage of cell 65 falls below −0.3 V (a significant reversal condition), transistor 68 should open and the transponder should respond with its identification when queried.

Operation of the transponder of FIG. 4 was simulated using SPICE (open source modeling software from Berkeley) and the circuit operated as planned. A working unit was then assembled and tested using a reader located 1 cm away. With simulated test cell voltages above the threshold of −0.3 V, the transponder was silent when queried. At voltages just below −0.3 V, the transponder properly transmitted its unique identification when queried. Operation of the transponder was found to be very repeatable. (In additional testing with the reader at different distances from the transponder, it was observed that the threshold voltage decreased somewhat with distance from the reader. Again however, transponder operation was very repeatable.) Operation of the transponder was then checked in various locations immediately adjacent an operating 150 kW heavy duty (for passenger buses) solid polymer electrolyte fuel cell stack running between 20 to 275 amps to see if electromagnetic noise affected operation. Except in the immediate vicinity of the system inverter cables, the digital response from the transponder was found to be consistent and repeatable. The circuit therefore performed as the model predicted.

This example demonstrates that an RFID based cell voltage monitor can operate successfully in a fuel cell environment. Further, minimal modifications to conventional apparatus are required to make a working transponder.

### Example 2

A second cell voltage monitoring system was constructed that gave improved performance over that of Example 1. In this case, a commercially available RFID tag and reader were employed that operated at the higher 13.56 MHz frequency. This higher frequency system provided faster data transmission and a reduction in response time.

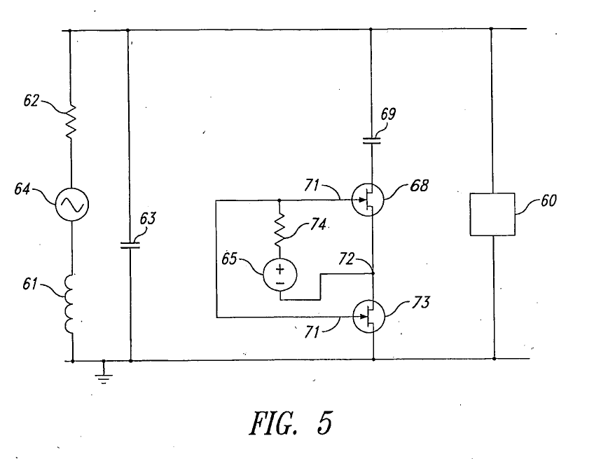

FIG. 5 shows a model of this operating transponder. (In FIG. 5, like components to those in FIG. 4 are labeled with the same numerals.) Here, a surface mount version of a MCRF450 tag 60 from Microchip was mounted on a thin, but rigid circuit board. The coil for powering tag 60 was comprised of circuit board traces on both sides of the board. Surface mount capacitors were used to tune the circuit for resonance. As in Example 1, a transistor based circuit and de-tuning capacitor were used to enable or disable the transponder from transmitting. However, in this example, the silencing circuit was comprised of two junction field effect transistors (JFETs) 68, 73, instead of one, in order to improve the switching performance. (Note the differences in the cathode and anode voltage inputs from simulated cell 65, which again appear at points denoted 71 and 72, respectively. Also note that series resistor 74 has been provided in the silencing circuit to protect transistors 68, 73. Such a resistor might also be employed in the circuit of FIG. 4 if desired.) The complete transponder assembly measured 1.2 cm in width, 5.1 cm in height and 0.8 mm in depth. MCRF450 tag 60 employs a built-in anti-collision mechanism that allows multiple tags to operate in close proximity to each other.

Three transponders were constructed as above and mounted side by side with a spacing of 1.8 mm to represent a typical fuel cell configuration. Inputs 71 and 72 of each transponder were then individually connected to 1.5 volt dc sources, whose polarity could be reversed by pressing a button. This transponder array was then brought into proximity to a Microchip Anti-Collision Interrogator (reader).

A positive voltage was applied to the electrode voltage inputs of each transponder and this simulated cell voltage monitoring system was then operated. With positive voltages across each set of inputs, the transponders remained silent and did not transmit their individual tag information (i.e., serial number). When the polarity of the voltage across a set of inputs was reversed however, the associated transponder properly transmitted its individual tag information, which was then interpreted and displayed on a computer screen. This test verified that the transponders could operate either individually, or all three at the same time, without interfering with each other in a typical fuel cell configuration.

The environment immediately surrounding the typical solid polymer electrolyte fuel cell is harsh for most electronics, with temperatures near 80° C. and a relatively humidity that can approach 100%. To demonstrate the ability to withstand this environment, two transponders similar to the above, were given a spray coating of conventional circuit board conformal coating, then dipped in silicon, and heat cured. A large beaker was then filled half-way with water, covered, and kept at a constant temperature of 80° C. One transponder was placed in the vapour space above the water and another transponder was placed under water. A reader was then positioned near the beaker so it could continuously read both transponders at the same time. This test was run for greater than 4 hours each day, for 5 days, without any failures.

While particular elements, embodiments and applications of the present invention have been shown and described herein for purposes of illustration, it will be understood, of course, that the invention is not limited thereto since modifications may be made by those skilled in the art without departing from the spirit and scope of the present disclosure, particularly in light of the foregoing teachings.

1. A fuel cell comprising a cathode, an anode, an electrolyte, and an RFID transponder, wherein the transponder is configured to sense and transmit information regarding an operating parameter of the fuel cell.

2. The fuel cell of claim 1 wherein the transponder is configured to transmit its identification when the operating parameter falls below a threshold value.

3. The fuel cell of claim 1 wherein the transponder is configured to transmit its identification when the operating parameter exceeds a threshold value.

4. The fuel cell of claim 1 wherein the transponder is configured to transmit the value of the operating parameter.

5. The fuel cell of claim 1 wherein the operating parameter is cell voltage.

6. The fuel cell of claim 1 wherein the operating parameter is cell impedance, a half cell voltage between a reference electrode and an electrode selected from the cathode and anode, cell temperature, a reactant pressure, stack compression, a reactant flow rate and the concentration of an impurity in a reactant.

7. The fuel cell of claim 1 wherein the transponder comprises a sensor having a cathode contact and an anode contact electrically connected to the cathode and the anode, respectively.

8. (canceled)

9. The fuel cell of claim 6 wherein the operating parameter is a half cell voltage between a reference electrode and an electrode selected from the cathode and anode and the transponder comprises a voltage sensor comprising the reference electrode.

10-11. (canceled)

12. The fuel cell of claim 6 wherein the operating parameter is a reactant pressure and the transponder comprises a pressure sensor comprising a strain gauge bridge.

13. (canceled)

14. The fuel cell of claim 6 wherein the operating parameter is stack compression and the transponder comprises a load cell sensor comprising a strain gauge bridge.

15-16. (canceled)

17. The fuel cell of claim 1 wherein the transponder comprises an A/D converter to convert the sensed operating parameter into digital form for transmission.

18. The fuel cell of claim 1 wherein the fuel cell is a solid polymer electrolyte fuel cell.

19. The fuel cell of claim 1 wherein the transponder is configured to sense and transmit information regarding more than one operating parameter of the fuel cell.

20. The fuel cell of claim 1 wherein the transponder is passive.

21. A fuel cell system comprising:
a fuel cell stack comprising a plurality of the fuel cell of claim 1 electrically connected in series; and
a reader for receiving information transmitted from the transponders.

22. The fuel cell system of claim 21 wherein the operating parameter is cell voltage.

23. The fuel cell system of claim 22 wherein each of the transponders is configured to transmit its identification to the reader when the cell voltage falls below a threshold value.

24. The fuel cell system of claim 23 wherein each of the transponders is dormant when the cell voltage is above the threshold value.

25. The fuel cell system of claim 21 wherein each fuel cell further comprises a membrane electrode assembly comprising the cathode, the anode, the electrolyte and an electrochemically inactive manifold section, and wherein the fuel cell stack further comprises a plurality of flow field plates arranged such that each fuel cell is interposed between two flow field plates.

26. The fuel cell system of claim 25 wherein each transponder is located in the manifold section of the membrane electrode assembly and each transponder comprises a sensor having a cathode pressure contact pad and an anode pressure contact pad, the cathode and anode pressure contact pads being mounted on opposing faces of the manifold section and electrically contacting the two adjacent flow field plates.

27. The fuel cell system of claim 26 wherein each transponder is molded into the manifold section of the membrane electrode assembly.

28. The fuel cell system of claim 21 wherein the fuel cell stack is a solid polymer electrolyte fuel cell stack.

29. The fuel cell system of claim 21 further comprising more than one reader.

30. A method of monitoring an operating parameter of a fuel cell, the method comprising:
incorporating an RFID transponder into the fuel cell, wherein the transponder is configured to sense and transmit information regarding the operating parameter;
sensing the operating parameter; and
transmitting information regarding the operating parameter to a reader.

31. The method of claim 30 comprising transmitting the identification of the transponder when the operating parameter falls below a threshold value.

32. The method of claim 30 comprising transmitting the identification of the transponder when the operating parameter exceeds a threshold value.

33. The method of claim 30 comprising transmitting the value of the operating parameter.

34. The method of claim 30 wherein the operating parameter is cell voltage.

35. The method of claim 30 wherein the operating parameter is cell impedance, a half cell voltage between a reference electrode and an electrode selected from the cathode and anode, cell temperature, a reactant pressure, stack compression, a reactant flow rate and the concentration of an impurity in a reactant.

36-41. (canceled)

42. A method of monitoring a fuel cell stack for voltage reversal in individual fuel cells of the fuel cell stack, the method comprising:
incorporating an RFID transponder into each fuel cell in the stack, wherein each transponder is configured to sense and transmit information regarding the cell voltage;
sensing the cell voltage, and
transmitting information regarding the cell voltage to a reader.

43. The method of claim 42 wherein the method comprises transmitting the identification of the transponder in a fuel cell when the sensed cell voltage falls below a threshold value.

44. The method of claim 43 wherein the transponder in each fuel cell is dormant when the cell voltage is above the threshold value.

45. The method of claim 42 wherein the fuel cell stack is a solid polymer electrolyte fuel cell stack.
